(19) United States
(12) Patent Application Publication
(10) Pub. No.: US 2026/0195209 A1
(43) Pub. Date: Jul. 9, 2026

(54) CROSS-MACHINE FEW-SHOT FAULT DIAGNOSIS METHOD BASED ON RETROSPECTIVE PROTOTYPICAL NETWORK (RPN)

(71) Applicant: Chongqing University, Chongqing (CN)

(72) Inventors: Yi QIN, Chongqing (CN); Qijun WEN, Chongqing (CN); Yongfang MAO, Chongqing (CN); Ning LI, Chongqing (CN)

(21) Appl. No.: 19/324,384

(22) Filed: Sep. 10, 2025

(30) Foreign Application Priority Data
Jan. 9, 2025 (CN) 202510034667.1

(51) Int. Cl. G06F 11/07

(52) U.S. Cl. CPC G06F 11/079; G06F 11/0709

(57) ABSTRACT

Provided is a cross-machine few-shot fault diagnosis method based on a retrospective prototypical network (RPN), which belongs to the technical field of fault diagnosis. First of all, through a multi-scale hybrid dilated convolutional feature extraction module, highly abstract sample features are extracted from a vibration signal acquired in a complex scenario. Then, a retrospective prototype representation and update method is proposed to optimize a class prototype with internal structures of data, more accurately reflecting a complex distribution of a class, and effectively reducing prototype oscillation and feature distribution differences between batches. In addition, a new similarity evaluation method, namely a central difference metric (CDM), is proposed to calculate a difference between the internal structures of the data, providing a more flexible similarity evaluation tool for a few-shot diagnosis task. At last, based on the above methods, an RPN is constructed, realizing accurate cross-machine and cross-condition fault diagnosis with limited samples.

### CROSS REFERENCE TO RELATED APPLICATION

This patent application claims the benefit and priority of Chinese Patent Application No. 202510034667.1, filed with the China National Intellectual Property Administration on Jan. 9, 2025, the disclosure of which is incorporated by reference herein in its entirety as part of the present application.

### TECHNICAL FIELD

The present disclosure belongs to the technical field of fault diagnosis, and relates to a cross-machine few-shot fault diagnosis method based on a retrospective prototypical network (RPN).

### BACKGROUND

As reliability and efficiency of mechanical equipment in operation are increasingly critical, importance of fault diagnosis becomes more prominent. Rolling bearings are key components in industrial equipment, and are fault-prone under harsh operating conditions. Hence, it is crucial to research intelligent fault diagnosis methods of the rolling bearings. Conventional deep learning-based fault diagnosis methods require a large amount of rich and low-interference data. However, in industrial application, it is expensive and impractical to acquire a large amount of fault data for each possible operating condition or machine. Therefore, the conventional diagnosis methods are often restricted seriously by data scarcity and domain shift. In order to overcome these challenges, methods based on transfer learning and few-shot learning are used frequently. However, the transfer learning-based methods still require enough samples to effectively align cross-domain distributions, while few-shot learning-based methods often exhibit poor generalization performance in cross-domain diagnosis tasks. Hence, cross-domain few-shot fault diagnosis methods for actual industrial scenarios are desired urgently.

Metric-based meta-learning methods mine high-level abstract knowledge, and evaluate a similarity between samples with a distance function, such that the model can quickly adapt to new fault diagnosis tasks in the few-shot target domain. Prototypical networks (ProtoNets) are well-known matrix-based meta-learning methods, but are difficult to accurately represent complex distributions of different classes. Meanwhile, the commonly used distance in the ProtoNets may not yield a satisfactory result. In recent years, a number of studies have focused on optimization of prototype representation and its update methods to enhance accurate representation abilities of the ProtoNets for different classes. Ren et al. proposed a granularity-aware area ProtoNet, which optimizes representation of class prototypes with relations between different granularities. Zhang et al. proposed a prototype calibration strategy, which adjusts the position of the prototype with a similarity-based weighting method, thereby reducing adverse effects of outlier samples on prototype representation. Huang et al. proposed a local descriptor-based multi-prototype network, which uses a local descriptor, rather than a global feature, to learn multiple prototypes to represent the classes. To mitigate prototype oscillation, Zhang et al. introduced a momentum algorithm to update prototypes, thereby overcoming adverse effects of feature distribution differences on model performance. On the other hand, improving the distance function can also enhance the classification ability of the ProtoNet. For example, Luo et al. modified the Euclidean distance with an elastic factor, and developed the elasticity metric, realizing more flexible classification. Wang et al. designed a correlation weighting Manhattan distance (CWMD) to accentuate the correlation between class prototypes, correcting adverse effects of interference values in conventional metrics. Vu et al. proposed a class covariance matrix based on local feature vectors, and applied the Mahalanobis distance to few-shot bearing fault diagnosis.

However, the above studies still have the following problems: 1) Existing prototype representation methods ignore internal structures of the data, including intra-class variability and relations between multi-dimensional features. Consequently, class prototypes cannot sufficiently represent a true sample distribution in the embedded space. Particularly for cross-domain diagnosis tasks, such prototypes restrict the classification ability of the network. 2) Metrics used by existing ProtoNets are mainly based on a distance between low-dimensional vectors, but do not represent differences between high-dimensional matrices of the data structures. Particularly, the low-dimensional vectors are vulnerable to the few-shot introduced deviation, and cannot make full use of information contained in limited samples. 3) To mitigate prototype oscillation and feature distribution differences between batches under few-shot conditions, existing methods constrain prototype shift with fixed empirical hyperparameters, but conversely restrict the active learning ability of the model.

In order to address these problems, an objective of the present disclosure is to provide a cross-machine few-shot fault diagnosis model. Through a multi-scale hybrid dilated convolutional feature extraction module, the model obtains highly abstract sample features, more effectively extracting fault information from a vibration signal acquired in a complex scenario. A retrospective prototype representation and update method is proposed to optimize representation of class prototypes with internal structures of data, thereby more accurately reflecting a complex distribution of the class, and effectively reducing prototype oscillation and feature distribution differences between batches. A new similarity evaluation method, namely a central difference metric (CDM), is proposed to calculate a difference between the internal structures of the data, without depending on an accurate and full-rank covariance matrix, providing a more flexible and adaptive similarity evaluation tool for few-shot diagnosis tasks. At last, based on the above methods, a new RPN with a cross-machine few-shot fault diagnosis framework is constructed, realizing more accurate and stable cross-machine and cross-condition fault diagnosis with limited samples.

### SUMMARY

In view of this, an objective of the present disclosure is to provide a cross-machine few-shot fault diagnosis method based on an RPN.

To achieve the above objective, the present disclosure provides the following technical solutions:

A cross-machine few-shot fault diagnosis method based on an RPN includes the following steps:
S1: acquiring bearing fault signal samples through a rolling bearing test bed;
S2: classifying a support set and a query set in a source domain and a target domain, and generating meta-tasks for a training stage and a testing stage;
S3: constructing a multi-scale hybrid dilated convolutional feature extraction module to obtain highly abstract sample features;
S4: calculating class prototypes, and retrospectively updating positions of the class prototypes in an embedded space;
S5: evaluating a similarity between a query sample and each of the class prototypes with a CDM, diagnosing a health state of the query sample, calculating a fusion loss, a separability loss, and a classification loss, and updating model parameters via backpropagation; and
S6: rapidly adapting to a meta-task in the target domain through a well-trained RPN, and diagnosing a health state of a sample in the target domain with a retrospective prototype and a CDM-based classifier.

Further, the step S3 includes: allowing the multi-scale hybrid dilated convolutional feature extraction module to use three convolutional layers of different sizes, and introducing an Inception module, further increasing diversity of features through parallel convolution at different scales.

Further, the step S3 includes: allowing the multi-scale hybrid dilated convolutional feature extraction module to use dilated convolution to expand a receptive field of a convolution kernel without increasing a number of parameters, so as to enhance an ability of the multi-scale hybrid dilated convolutional feature extraction module to capture a larger local structure.

Further, the step S3 includes: allowing the multi-scale hybrid dilated convolutional feature extraction module to flexibly integrate multi-scale features with an adaptive pooling layer to obtain the highly abstract sample features, effectively extracting fault information from a vibration signal acquired in a complex scenario.

Further, the step S4 includes: in a p-dimensional embedded space, defining a sample feature matrix of an nth class as

$${F}_{n} = {( {f}_{1 , n}^{S} , {f}_{2 , n}^{S} , … , {f}_{k , n}^{S} )}^{T} ,$$

where a sample feature

$${f}_{i , n}^{S}$$

includes p eigenvalues; and a mean of a sample of the nth class is represented as

$${μ}_{n} = \frac{1}{k} {\sum }_{i = 1}^{k} {f}_{i , n}^{S} ;$$

and
defining a new prototype with a covariance matrix, and calculating the new prototype by:

$${P}_{n} = {\sum }_{n} = \frac{1}{k - 1} {\sum }_{i = 1}^{k} {( {f}_{i , n}^{S} - {μ}_{n} )}^{T} \cdot ( {f}_{i , n}^{S} - {μ}_{n} )$$

where Pₙ represents a class prototype of the nth class, and Σₙ represents a covariance matrix of the nth class.

Further, the step S4 includes: assuming a prototype of an ith batch as

$${\tilde{P}}_{n}^{( i )} ,$$

and a prototype of an (i+1)th batch as

$${P}_{n}^{( i + 1 )} ;$$

and with two model-independent parameters, including a historical weight α and a present weight β, performing retrospective update, a retrospective prototype of the (i+1)th batch being represented as:

$${\tilde{P}}_{n}^{( i + 1 )} = α {\tilde{P}}_{n}^{( i )} + β {P}_{n}^{( i + 1 )}$$

where α and β are learnable parameters; and during network training, the retrospective prototype is represented as:

$${\tilde{P}}_{n}^{( i + 1 )} = α ( α {\tilde{P}}_{n}^{( i - 1 )} + β {P}_{n}^{( i )} ) + β {P}_{n}^{( i + 1 )} = β {P}_{n}^{( i + 1 )} + αβ {P}_{n}^{( i )} + {α}^{2} β {P}_{n}^{( i - 1 )} + … + {α}^{i} β {P}_{n}^{( 1 )} .$$

Further, the step S5 includes: assuming that

$${f}_{n}^{Q}$$

represents a query sample feature of an nth class, and defining a central feature matrix of the query sample as:

$${\sum }_{n}^{Q} = \frac{1}{k - 1} {\sum }_{i = 1}^{k} {( {f}_{i , n}^{S} - {f}_{n}^{Q} )}^{T} \cdot ( {f}_{i , n}^{S} - {f}_{n}^{Q} )$$

$$where {\sum }_{n}^{Q}$$

is a pseudo-covariance matrix; the central feature matrix of the query sample is equivalent to an observed distribution for different class samples with the query sample as a center; when the query sample belongs to a class, the central feature matrix of the query sample has a relatively high similarity with a central feature matrix generated by a support sample of the class, specifically a high similarity with a distribution represented by a class prototype of the class; and the CDM is defined as:

$${d}_{CDM} ( {f}_{n}^{Q} , {P}_{n} ) = {‖ {\sum }_{n}^{Q} - {\sum }_{n} ‖}_{F} .$$

Further, in the step S5, a class predicted probability is:

$$p ( y = n ) = \frac{{e}^{( - {d}_{CDM} ( {f}_{n}^{Q} , {P}_{n} ) )}}{{\sum }_{j = 1}^{N} {e}^{( - {d}_{CDM} ( {f}_{n}^{Q} , {P}_{j} ) )}} .$$

Further, in the step S5, the fusion loss L_{F} is used to reduce a difference between internal structures of data in

$${\tilde{P}}_{n}^{( i + 1 )} , {\tilde{P}}_{n}^{( i )} and {P}_{n}^{( i + 1 )} ,$$

and fuse prototype information of a historical batch and prototype information of a present batch, and includes two loss items: an extent loss l_{E} and a deviation loss l_{D}; and a fusion loss of an (i+1)th batch is:

$${L}_{F}^{( i + 1 )} ( α , β , λ ) = {\sum }_{n = 1}^{N} {l}_{n , F}^{( i + 1 )} ( α , β , λ ) = {\sum }_{n = 1}^{N} [ λ {l}_{E}^{( i + 1 )} ( α , β ) + ( 1 - λ ) {l}_{D}^{( i + 1 )} ( α , β ) ]$$

$${l}_{E}^{( i + 1 )} ( α , β ) = {( α {‖ {\tilde{P}}_{n}^{( i + 1 )} - {\tilde{P}}_{n}^{( i )} ‖}_{F} + β {‖ {\tilde{P}}_{n}^{( i + 1 )} - {P}_{n}^{( i + 1 )} ‖}_{F} )}^{2}$$

$${l}_{D}^{( i + 1 )} ( α , β ) = {( α {‖ {\tilde{P}}_{n}^{( i + 1 )} - {\tilde{P}}_{n}^{( i )} ‖}_{F} - β {‖ {\tilde{P}}_{n}^{( i + 1 )} - {P}_{n}^{( i + 1 )} ‖}_{F} )}^{2}$$

$$where {l}_{n , F}^{( i + 1 )}$$

is a class fusion loss of the (i+1)th batch; λ is a weighting parameter;

$${l}_{E}^{( i + 1 )} ( α , β )$$

represents an extent of fusion for information of multiple batches;

$${l}_{D}^{( i + 1 )} ( α , β )$$

is an extent of deviation; and ∥⋅∥_{F} represents a Frobenius norm.

Further, in the step S5, to enhance separability between the retrospective prototype and an updated class prototype, a separability loss L_{S} of an (i+1) batch is:

$${L}_{S}^{( i + 1 )} ( α , β ) = ( α + β ) {\sum }_{n = 1}^{N} {\sum }_{m = n + 1}^{N} {‖ {\tilde{P}}_{n}^{( i + 1 )} - {\tilde{P}}_{m}^{( i + 1 )} ‖}_{F}^{2} .$$

The present disclosure has the following beneficial effects:
(1) The present disclosure provides a retrospective prototype method, which optimizes representation of class prototypes with internal structures of data, thereby more accurately reflecting a complex distribution of the class. Meanwhile, the method effectively reduces prototype oscillation and feature distribution differences between batches. In addition, all parameters of the present disclosure are model-independent and randomly initialized. These parameters are updated with a new loss function through backpropagation, enhancing inter-class separability.
(2) The present disclosure proposes a new similarity evaluation method, namely the CDM. The method calculates differences between the internal structures of the data, including intra-class variability and multidimensional correlation. Particularly, the CDM does not depend on an accurate and full-rank covariance matrix, providing a more flexible and adaptive similarity evaluation tool for few-shot diagnosis tasks.
(3) On the basis of the retrospective prototype and the CDM, the present disclosure constructs a new RPN with a cross-machine few-shot fault diagnosis framework. The method can realize cross-machine and cross-condition fault diagnosis with limited samples. With comparison on experimental results, the method outperforms other classical and cutting-edge fault diagnosis methods.

Other advantages, objectives and features of the present disclosure will be illustrated in the subsequent description in some degree, and will be apparent to those skilled in the art in some degree based on study on the following description, or those skilled in the art may obtain teachings by practicing the present disclosure. The objectives and other advantages of the present disclosure can be implemented and obtained by the description below.

### BRIEF DESCRIPTION OF THE DRAWINGS

In order to make the objectives, technical solutions, and advantages of the present disclosure clearer, the present disclosure will be preferably described in detail below with reference to the accompanying drawings.

FIG. 1 is a diagnostic flowchart of an RPN;

FIG. 2 illustrates a structure of a multi-scale hybrid dilated convolutional feature extraction module;

FIG. 3 illustrates a covariance matrix-based prototype and a similarity metric;

FIG. 4 is a schematic diagram of an RPN;

FIGS. 5A-5E illustrate sample analysis of three datasets;

FIGS. 6A-6F illustrate confusion matrices of six methods in T1;

FIG. 7 illustrates a violin plot of a diagnostic result;

FIG. 8 illustrates comparison of four models in convergence; and

FIGS. 9A-9D illustrate comparison on two update modes in prototype fluctuation in four health states.

### DETAILED DESCRIPTION OF THE EMBODIMENTS

The implementations of the present disclosure are described below through specific examples, and those skilled in the art can easily understand other advantages and effects of the present disclosure from the contents disclosed in this specification. The present disclosure can also be implemented or applied through other different specific implementations. Based on different viewpoints and applications, various modifications or amendments can be made to various details of this specification without departing from the spirit of the present disclosure. It should be noted that the diagrams provided in the following embodiments merely illustrate the basic conception of the present disclosure only schematically, and the following embodiments or features in the embodiments may be combined in a non-conflicting manner.

The accompanying drawings are schematic diagrams rather than physical diagrams, which are only for illustrative description and should not be construed as a limitation to the present disclosure. In order to better describe the embodiments of the present disclosure, some components may be omitted, enlarged or reduced in the accompanying drawings, and thus do not represent true sizes of physical products. Those skilled in the art should understand that some well-known structures and descriptions thereof may be omitted in the accompanying drawings.

The same or similar labels in the accompanying drawings of the embodiment of the present disclosure correspond to the same or similar components. In the description of the present disclosure, it should be understood that orientation or position relationships indicated by terms such as “upper”, “lower”, “left”, “right”, “front” and “rear” are orientation or position relationships as shown in the drawings. These terms are merely intended to facilitate and simplify the description of the present disclosure, rather than to indicate or imply that the mentioned device or component must have a specific orientation or must be constructed and operated in a specific orientation. Therefore, the terms describing the positional relationship in the accompanying drawings are only used for illustrative description, and should not be understood as a limitation to the present disclosure. A person of ordinary skill in the art will understand specific meanings of such terms based on a specific situation.

A cross-machine few-shot fault diagnosis method based on an RPN includes the following steps:
S1: Bearing fault signal samples are acquired through a rolling bearing test bed.
S2: A support set and a query set are classified in a source domain and a target domain, and meta-tasks for a training stage and a testing stage are generated.
S3: A multi-scale hybrid dilated convolutional feature extraction module is constructed to obtain highly abstract sample features.
S4: Class prototypes are calculated, and positions of the class prototypes in an embedded space are retrospectively updated.
S5: A similarity between a query sample and each of the class prototypes is evaluated with a CDM, a health state of the query sample is diagnosed, a fusion loss, a separability loss, and a classification loss are calculated, and model parameters are updated via backpropagation.
S6: A meta-task in the target domain is rapidly adapted through a well-trained RPN, and a health state of a sample in the target domain is diagnosed with a retrospective prototype and a CDM-based classifier.

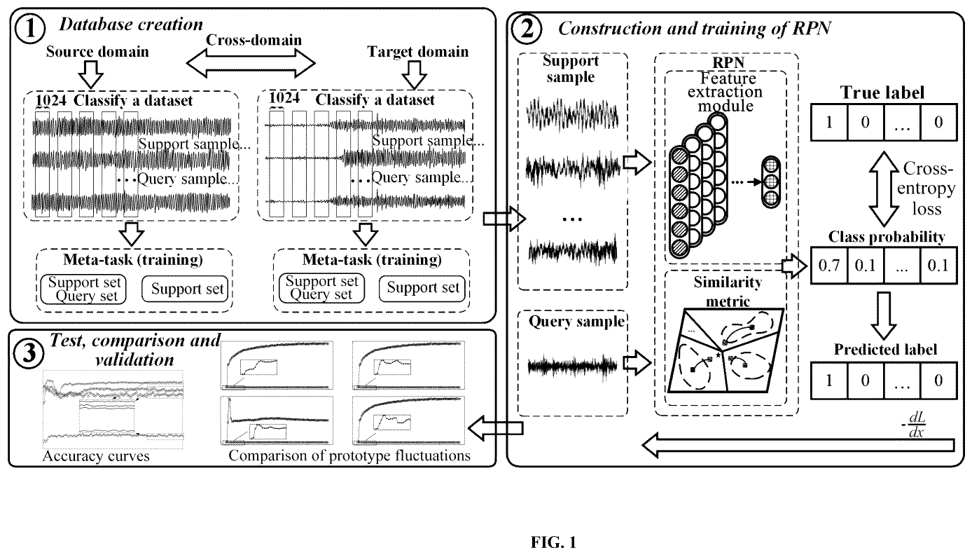

The specific flowchart is shown in FIG. 1.

Further, Step S3 specifically includes:

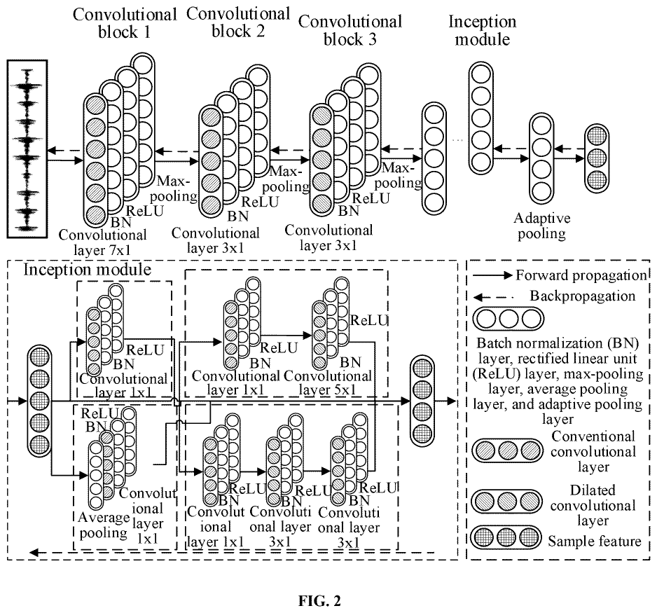

As shown in FIG. 2, the multi-scale hybrid dilated convolutional feature extraction module uses three convolutional layers of different sizes, and an Inception module is introduced, further increasing diversity of features through parallel convolution at different scales. In addition, the multi-scale hybrid dilated convolutional feature extraction module uses dilated convolution to expand a receptive field of a convolution kernel without increasing a number of parameters, enhancing an ability of the multi-scale hybrid dilated convolutional feature extraction module to capture a larger local structure. At last, multi-scale features are flexibly integrated with an adaptive pooling layer to obtain the highly abstract sample features, effectively extracting fault information from a vibration signal acquired in a complex scenario.

Further, through a retrospective prototype method, representation of class prototypes is optimized with internal structures of data, thereby more accurately reflecting a complex distribution of the class, and effectively reducing prototype oscillation and feature distribution differences between batches. In addition, all parameters of the retrospective prototype method are model-independent and randomly initialized. These parameters are updated with a new loss function through backpropagation, enhancing inter-class separability.

In a p-dimensional embedded space, a sample feature matrix of an nth class is defined as

$${F}_{n} = {( {f}_{1 , n}^{S} , {f}_{2 , n}^{S} , … , {f}_{k , n}^{S} )}^{T} ,$$

where a sample feature

$${f}_{i , n}^{S}$$

includes p eigenvalues; and a mean of a sample of the nth class is represented as

$${μ}_{n} = \frac{1}{k} {\sum }_{i = 1}^{k} {f}_{i , n}^{S} .$$

Considering that the covariance matrix of the sample calculated by a moment estimation method (MEM) can capture variability of the class feature distribution and the multi-dimensional correlation, a new prototype is defined with a covariance matrix, and calculated by:

$${P}_{n} = {\sum }_{n} = \frac{1}{k - 1} {\sum }_{i = 1}^{k} {( {f}_{i , n}^{S} - {μ}_{n} )}^{T} \cdot ( {f}_{i , n}^{S} - {μ}_{n} )$$

where Pₙ represents a class prototype of the nth class, and Σₙ represents a covariance matrix of the nth class.

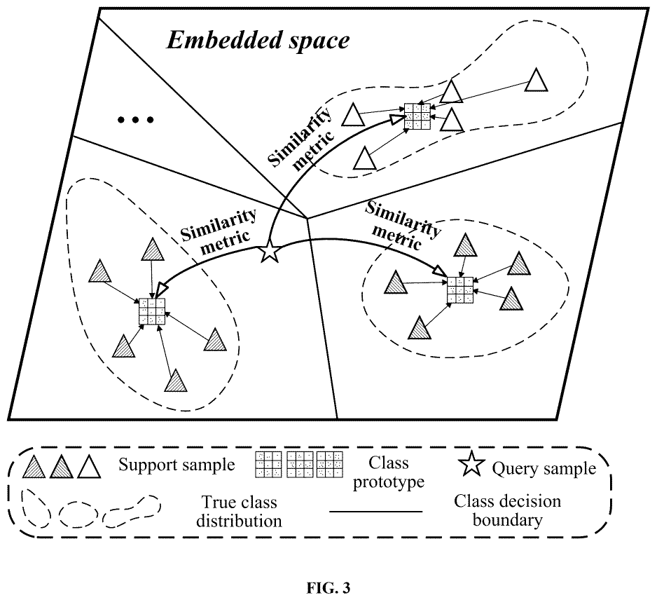

As shown in FIG. 3, the class prototype is represented with the covariance matrix, and the conventional distance metric is converted into evaluation on a similarity between the query sample and each of covariance matrices of different classes.

In few-shot scenarios, limited samples may cause a significant difference between feature distributions of different batches. To address this problem, covariance matrices of adjacent batches are fused to prototype update, namely the retrospective prototype method. Specifically, it is assumed that a prototype of an ith batch is

$${\tilde{P}}_{n}^{( i )} ,$$

and a prototype of an (i+1)th batch is

$${P}_{n}^{( i + 1 )} .$$

Then, with two model-independent parameters, including a historical weight α and a present weight β, retrospective update is performed. A retrospective prototype of the (i+1)th batch is represented as:

$${\tilde{P}}_{n}^{( i + 1 )} = α {\tilde{P}}_{n}^{( i )} + β {P}_{n}^{( i + 1 )}$$

where α and β are learnable parameters. During network training, the retrospective prototype can be represented as:

$${\tilde{P}}_{n}^{( i + 1 )} = α ( α {\tilde{P}}_{n}^{( i - 1 )} + β {P}_{n}^{( i )} ) + β {P}_{n}^{( i + 1 )} = β {P}_{n}^{( i + 1 )} + αβ {P}_{n}^{( i )} + {α}^{2} β {P}_{n}^{( i - 1 )} + … + {α}^{i} β {P}_{n}^{( 1 )}$$

As can be seen from the above Eq., the retrospective prototype method integrates prototypes of different batches and takes intra-class variability between the different batches into account. Therefore, compared with the existing prototype representation method, this method can represent the class prototype more accurately, and can better suppress the prototype oscillation.

To adaptively fuse the

$${\tilde{P}}_{n}^{( i )} and the {P}_{n}^{( i + 1 )}$$

to represent the class prototype, a following loss function is designed to update the parameters α and β through backpropagation.
1) Fusion loss L_{F}: The L_{F} is used to reduce a difference between internal structures of data in

$${\tilde{P}}_{n}^{( i + 1 )} , {\tilde{P}}_{n}^{( i )} and {P}_{n}^{( i + 1 )} ,$$

and fuse prototype information of a historical batch and prototype information of a present batch. It includes two loss items: an extent loss l_{E} and a deviation loss l_{D}. a fusion loss of an (i+1)th batch is:

$${L}_{F}^{( i + 1 )} ( α , β , λ ) = {\sum }_{n = 1}^{N} {l}_{n , F}^{( i + 1 )} ( α , β , λ ) = {\sum }_{i = 1}^{N} [ λ {l}_{E}^{( i + 1 )} ( α , β ) + ( 1 - λ ) {l}_{D}^{( i + 1 )} ( α , β ) ]$$

$${l}_{E}^{( i + 1 )} ( α , β ) = {( α {‖ {\tilde{P}}_{n}^{( i + 1 )} - {\tilde{P}}_{n}^{( i )} ‖}_{F} + β {‖ {\tilde{P}}_{n}^{( i + 1 )} - {P}_{n}^{( i + 1 )} ‖}_{F} )}^{2}$$

$${l}_{D}^{( i + 1 )} ( α , β ) = {( α {‖ {\tilde{P}}_{n}^{( i + 1 )} - {\tilde{P}}_{n}^{( i )} ‖}_{F} - β {‖ {\tilde{P}}_{n}^{( i + 1 )} - {P}_{n}^{( i + 1 )} ‖}_{F} )}^{2}$$

$$where {l}_{n , F}^{( i + 1 )}$$

is a class fusion loss of the (i+1)th batch; λ is a weighting parameter;

$${l}_{E}^{( i + 1 )} ( α , β )$$

represents an extent of fusion for information of multiple batches;

$${l}_{D}^{( i + 1 )} ( α , β )$$

is an extent of deviation; and ∥⋅∥_{F} represents a Frobenius norm.
2) Separability loss L_{S}: The retrospective update method affects relative positions of various class prototypes. To enhance separability between the retrospective prototype and an updated class prototype, a separability loss of an (i+1) batch is designed as:

$${L}_{S}^{( i + 1 )} ( α , β ) = ( α + β ) {\sum }_{i = 1}^{N} {\sum }_{m = n + 1}^{N} {‖ {\tilde{P}}_{n}^{( i + 1 )} - {\tilde{P}}_{m}^{( i + 1 )} ‖}_{F}^{2}$$

3) Classification loss L_{C}: The L_{C} is used to minimize a classification risk. The cross-entropy loss function of the RPN is defined as:

$${l}_{n , C}^{( i + 1 )} ( φ ) = - log p ( y = n )$$

where φ is a network parameter of the multi-scale hybrid dilated convolutional feature extraction module, and p(y=n) is a probability that the query sample belongs to the class n.

Therefore, the classification loss of the (i+1)th batch is:

$${L}_{C}^{( i + 1 )} ( φ ) = {\sum }_{n = 1}^{N} {l}_{n , C}^{( i + 1 )} ( φ )$$

To sum up, the total loss function L_{T} of the (i+1)th batch is:

$${L}_{T}^{( i + 1 )} ( φ , α , β , λ ) = {L}_{C}^{( i + 1 )} ( φ ) + \frac{{L}_{F}^{( i + 1 )} ( α , β , λ )}{{L}_{S}^{( i + 1 )} ( α , β )}$$

Network parameters are updated with an adaptive moment estimation (Adam) optimizer. During parameter update, different learning rates are assigned to different parameters to adapt to their sizes. With these learning rates and the above losses, all parameters can be iteratively updated by:

$$φ ← φ - {{ε}_{1} ( \frac{\partial {L}_{C}}{\partial φ} )}_{Adam}$$

$$α ← α - {{ε}_{2} ( \frac{1}{{L}_{S}} \frac{\partial {L}_{F}}{\partial α} - \frac{{L}_{F}}{{L}_{S}^{2}} \frac{\partial {L}_{S}}{\partial α} )}_{Adam}$$

$$β ← β - {{ε}_{2} ( \frac{1}{{L}_{S}} \frac{\partial {L}_{F}}{\partial β} - \frac{{L}_{F}}{{L}_{S}^{2}} \frac{\partial {L}_{S}}{\partial β} )}_{Adam}$$

$$λ ← λ - {{ε}_{2} ( \frac{1}{{L}_{S}} \frac{\partial {L}_{F}}{\partial λ} )}_{Adam}$$

where ε₁ is set as 0.00001, and ε₂ is set as 0.001. The parameter φ is randomly initialized, and the parameters α, β and λ are randomly initialized within a range (0,1), so as to prevent gradient exploding or vanishing.

Further, a new similarity evaluation method, namely a CDM, is proposed. The method calculates differences between the internal structures of the data, including intra-class variability and multidimensional correlation. Particularly, the CDM does not depend on an accurate and full-rank covariance matrix, providing a more flexible and adaptive similarity evaluation tool for few-shot diagnosis tasks.

It is assumed that

$${f}_{n}^{Q}$$

represents a query sample feature of an nth class. A central feature matrix of the query sample is defined as:

$${\sum }_{n}^{Q} = \frac{1}{k - 1} {\sum }_{i = 1}^{k} {( {f}_{i , n}^{S} - {f}_{n}^{Q} )}^{T} \cdot ( {f}_{i , n}^{S} - {f}_{n}^{Q} )$$

$$where {\sum }_{n}^{Q}$$

can be considered as a pseudo-covariance matrix. It is to be noted that the central feature matrix of the query sample is equivalent to an observed distribution for different class samples with the query sample as a center. When the query sample belongs to a class, the central feature matrix of the query sample has a relatively high similarity with a central feature matrix generated by a support sample of the class, namely a high similarity with a distribution represented by a class prototype of the class. Therefore, the CDM is proposed, and defined as:

$${d}_{CDM} ( {f}_{n}^{Q} , {P}_{n} ) = {‖ {\sum }_{n}^{Q} - {\sum }_{n} ‖}_{F}$$

The similarity metric method is based on differences between internal structures of high-dimensional data, and can make full use of information contained in limited samples to evaluate the similarity between the query sample and each of different class prototypes. In addition, the proposed method depends on differences between the central feature matrix and the class prototype, prevents matrix inversion, and does not depend on the accurate covariance matrix of each class. Compared with the classical Mahalanobis distance and variants thereof, the CDM is more suitable for few-shot fault diagnosis scenarios.

At last, a class predicted probability output by the RPN is:

$$p ( y = n ) = \frac{{e}^{( - {d}_{CDM} ( {f}_{n}^{Q} , {P}_{n} ) )}}{{\sum }_{j = 1}^{N} {e}^{( - {d}_{CDM} ( {f}_{n}^{Q} , {P}_{j} ) )}}$$

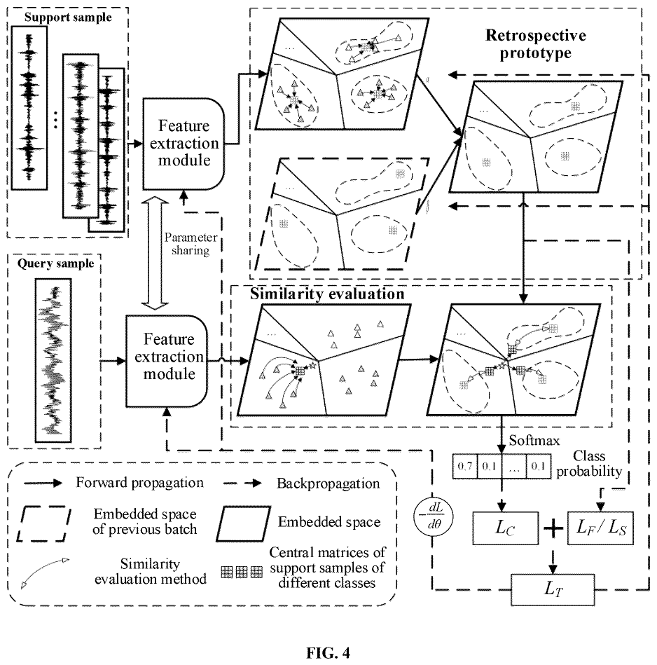

With the proposed feature extraction module, retrospective prototype method and the similarity metric method, the RPN for the cross-machine few-shot fault diagnosis model is constructed, with the schematic diagram shown in FIG. 4.

In order to validate effectiveness of the proposed model, three datasets, including the Southwest Jiaotong University (SWJTU) bearing dataset, the Southeast University (SEU) bearing dataset, and the bearing fault detection (BFD) dataset, are used.

The SWJTU bearing dataset is acquired by the SWJTU. This dataset includes four different health states, including a healthy state (Hea), an inner race fault (IF), a rolling body fault (BF), and an outer race fault (OF). For this database, data acquired when the rotational speed is 896.1 rpm and the load is 3 Nm are used.

The SEU bearing dataset is acquired by the SEU. This dataset includes five health states, including a Hea, an IF, a BF, an OF, and an inner and outer race fault (IOF). For this database, data acquired when the rotational speed is 1,200 rpm and the load is 0 Nm are used.

Meanwhile, the customized bearing testbed is used, and vibration signals of the bearing in variable operating conditions are acquired. In experiments, vibration signals in five health states, including the Hea, the IF, the BF, the OF, and the IOF, are acquired. Under the time-varying rotational speed from 100 rpm to 500 rpm (the changing rate is 300 rpm/s) and 2-Nm load, each health state is tested. The acquired dataset is named as the BFD dataset.

Table 1 provides detailed information of the three datasets. As shown in Table 2, six cross-bearing few-shot tasks are constructed with these datasets to validate the effectiveness of the proposed method. It is to be noted that in each health state, 20 samples are used for training, and 200 samples are used for testing. The sample length is set as 1,024.

TABLE 1

| Name | Dataset | Rotational speed | Load |
|---|---|---|---|
| A | SWJTU | 896.1 rpm | 3 Nm |
| B | SEU | 1,200 rpm | 0 Nm |
| C | BFD | 100 to 500 rpm (300 rpm/s) | 2 Nm |

TABLE 2

| | | | Source | Target |
|---|---|---|---|---|
| Task | Training class | Testing class | domain | domain |
| T₁ | Hea, IF, OF, BF | Hea, IF, OF, BF | A | B |
| T₂ | Hea, IF, OF, BF | Hea, IF, OF, BF | B | A |
| T₃ | Hea, IF, OF, BF | Hea, IF, OF, BF | A | C |
| T₄ | Hea, IF, OF, BF | Hea, IF, OF, BF | C | A |
| T₅ | Hea, IF, OF, BF, IOF | Hea, IF, OF, BF, IOF | B | C |
| T₆ | Hea, IF, OF, BF, IOF | Hea, IF, OF, BF, IOF | C | B |

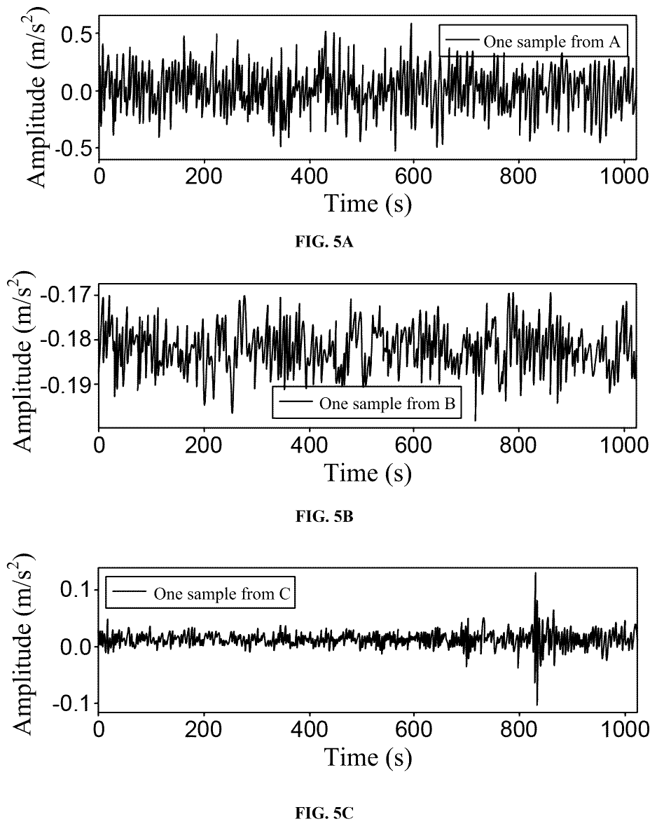

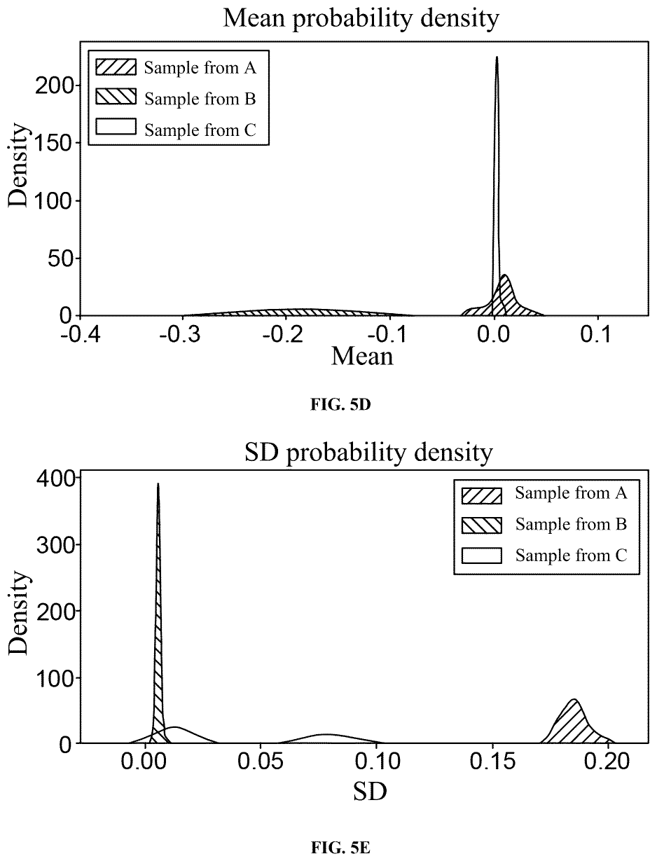

Three samples are selected from the three datasets respectively, with waveforms shown by the left part in FIGS. 5A-5E. For 1,000 healthy samples in each dataset, the probability density curve of the mean and the probability density curve of the standard deviation (SD) are shown by the right part in FIGS. 5A-5E. As can be seen from the right part in FIGS. 5A-5E, data distributions of different bearings are significantly different. Particularly, the probability density curve of the SD of the dataset C exhibits an obvious double-peak phenomenon, indicating intra-class variability of the vibration signal with the time-varying operating condition.

To fully evaluate effectiveness and superiority of the RPN, the proposed RPN is compared with several classical and cutting-edge fault diagnosis methods, including a variance difference representation (VDR), a ProtoNet, a relational network (RelaNet), a model-agnostic meta-learning (MAML), and a generalized model-agnostic meta-learning (GMAML). The VDR is an advanced cross-machine fault diagnosis transfer learning method, while the ProtoNet, the RelaNet and the MAML are classical few-shot learning methods and typically used as a basic framework. As an enhanced metal-learning method, the GMAML is excellent in cross-domain few-shot fault diagnosis. During a meta-training stage, 100 epochs are set, and each epoch includes 30 batches. During a testing stage, 200 meta-tasks are input to a well-trained model, with an average accuracy rate and an SD recorded. All experiments are repeated 10 times to mitigate influences of randomness.

In six cross-bearing few-shot scenarios, all experimental results are listed in Table 3. Compared with the ProtoNet, accuracy rates of the RPN in six tasks are respectively improved by 42.24%, 40.78%, 2.32%, 27.07%, 38.14%, and 48.36%, with an average accuracy rate improved by 33.15%. It can be seen that the proposed method greatly improves performance of the ProtoNet. In terms of the six tasks, accuracy rates of the RPN are respectively improved by 7.71%, 11.94%, 28.02%, 13.90%, 22.71%, and 5.11% over the advanced cross-domain few-shot method GMAML, further demonstrating the superiority of the RPN. In Ts, the source domain and the target domain are significantly different, data in the target domain is acquired in variable operating conditions, and the classification task is more challenging. However, the RPN still achieves the accuracy rate of 77.57%, which is improved by 22.71% over the followed method GMAML, and significantly outperforms other compared methods. These results reflect superior performance of the RPN in cross-machine and cross-condition few-shot fault diagnosis.

TABLE 3

| | Cross-machine 5-shot diagnosis task (%) | | | | | | |
|---|---|---|---|---|---|---|---|
| Method | T₁ | T₂ | T₃ | T₄ | T₅ | T₆ | Average |
| VDR | 26.12 ± 7.16 | 22.25 ± 5.88 | 32.69 ± 6.68 | 27.49 ± 5.85 | 21.67 ± 5.43 | 23.79 ± 5.31 | 25.67 ± 6.05 |
| RelaNet | 24.39 ± 1.86 | 27.72 ± 2.48 | 47.51 ± 2.42 | 31.99 ± 3.76 | 23.27 ± 3.28 | 21.49 ± 1.48 | 29.40 ± 2.55 |
| ProtoNet | 48.53 ± 4.11 | 48.85 ± 5.64 | 83.81 ± 2.28 | 65.09 ± 3.44 | 39.43 ± 3.49 | 36.89 ± 4.33 | 53.77 ± 3.88 |
| MAML | 59.15 ± 5.48 | 58.83 ± 6.24 | 64.49 ± 4.58 | 35.07 ± 3.54 | 37.36 ± 3.64 | 27.51 ± 2.21 | 47.07 ± 4.28 |
| GMAML | 83.06 ± 2.72 | 77.69 ± 2.34 | 58.11 ± 4.43 | 78.26 ± 2.61 | 54.86 ± 3.69 | 80.14 ± 3.22 | 72.02 ± 3.17 |
| Proposed | 90.77 ± 4.41 | 89.63 ± 6.37 | 86.13 ± 5.48 | 92.16 ± 4.89 | 77.57 ± 7.06 | 85.25 ± 5.81 | 86.92 ± 5.67 |

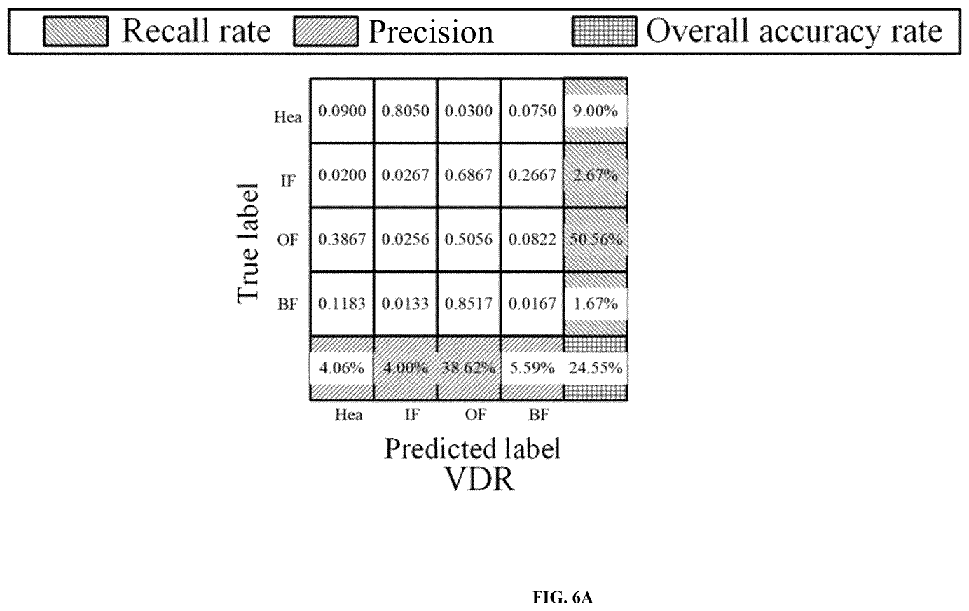

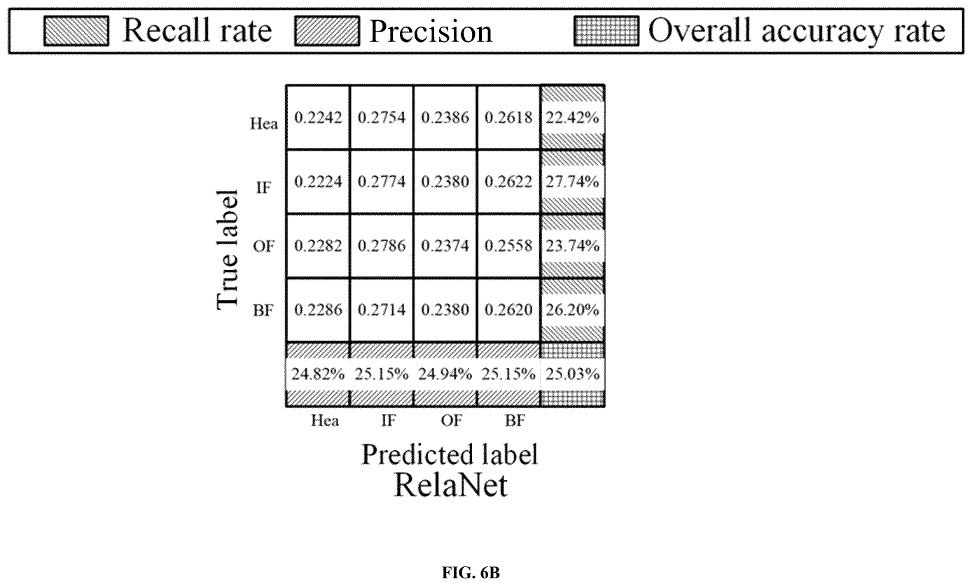

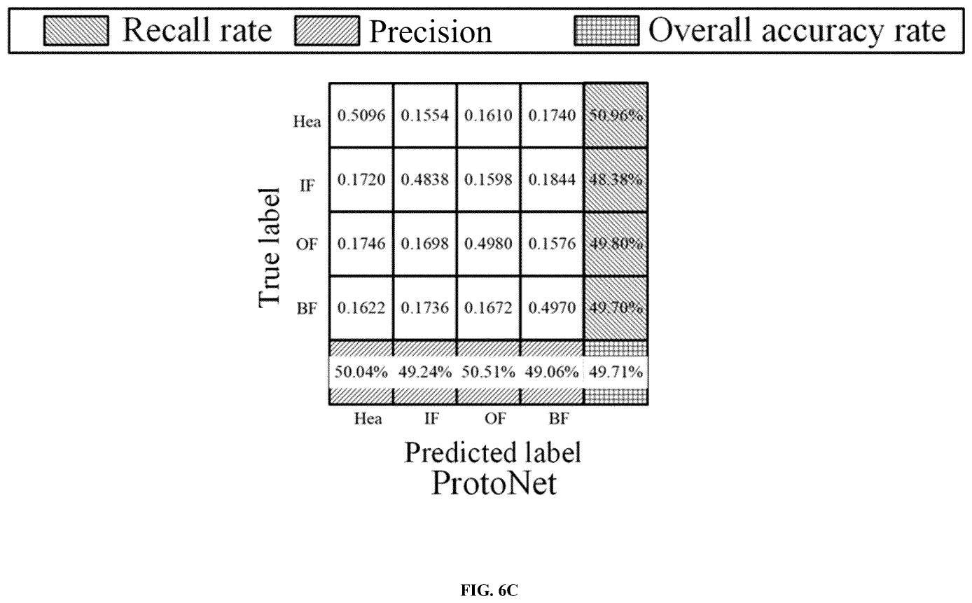

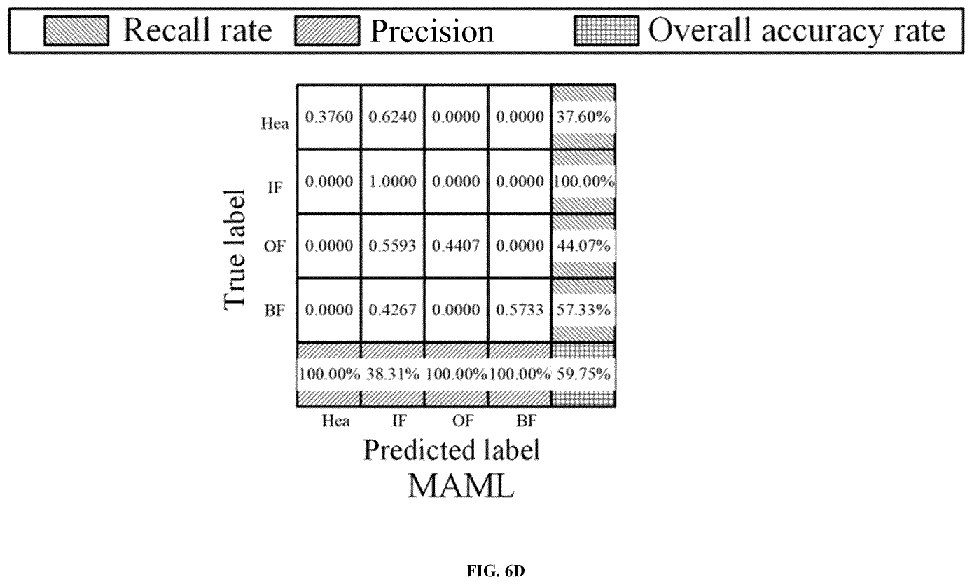

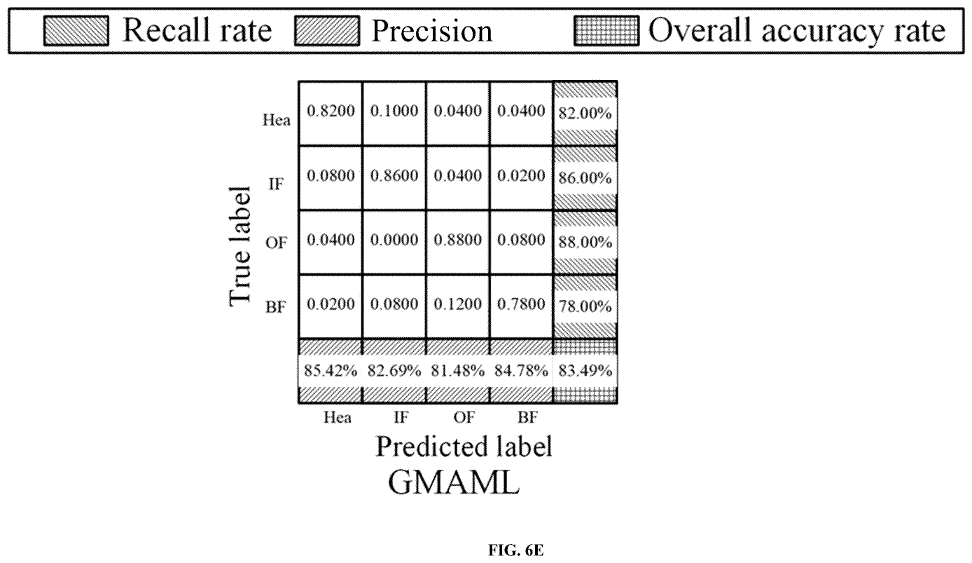

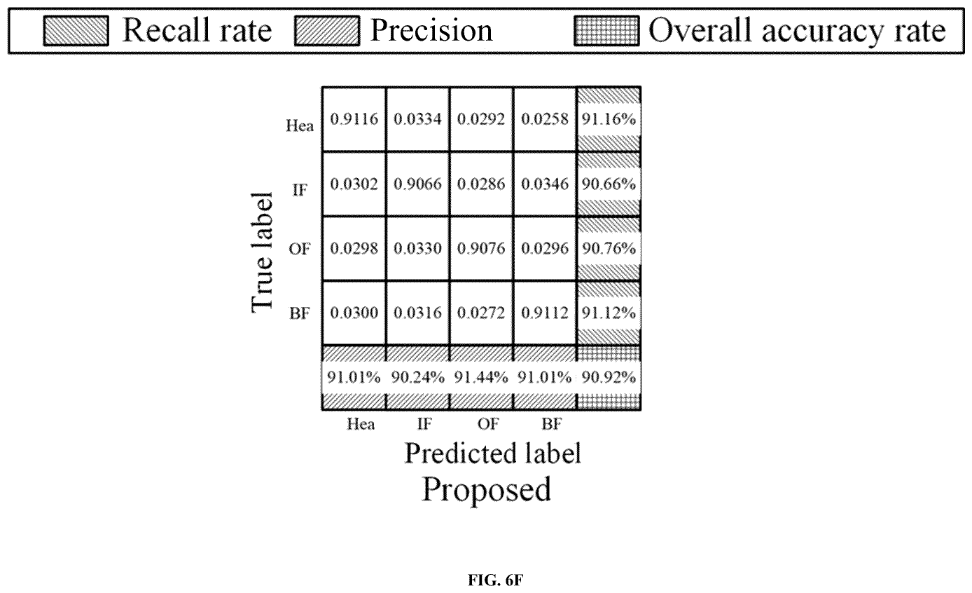

To compare the RPN with the above classical and cutting-edge methods from multiple perspectives in detail, with T₁ as an example, the confusion matrix including the precision and the recall rate is drawn, as shown in FIGS. 6A-6F. For each health state, the RPN outperforms other methods except the MAML in terms of the overall accuracy rate, precision and recall rate. The MAML yields a high precision and a high recall rate in some health states, but its overall accuracy rate is far less than that of the RPN. Therefore, compared with other cutting-edge methods, the RPN has higher accuracy of fault diagnosis and higher reliability.

To illustrate positive effects of the proposed retrospective prototype and CDM on the performance of the fault diagnosis model, the T₁ is taken as an example to carry out an ablation experiment.

Four different models, including the proposed RPN, a Mahalanobis distance-based model, a Euclidean distance-based model and an RPN not using the retrospective prototype, are applied to the task T₁. The “Mahalanobis distance”-based model means that the CDM in the RPN is replaced by the Mahalanobis distance. To achieve stable performance of the Mahalanobis distance-based model in the few-shot scenarios, ridge regression is used to ensure reversibility of the covariance matrix. The “Euclidean distance”-based model is formed in a similar way. The model “not using the retrospective prototype” means that the proposed prototype is used, but the RPN is not retrospectively updated. The average accuracy rates and SDs of the four models are shown in Table 4.

TABLE 4

| Model configuration | Result (%) |
|---|---|
| Proposed method | 90.77 ± 4.41 |
| Euclidean distance-based model | 66.96 ± 6.33 |
| Mahalanobis distance-based model | 84.86 ± 5.38 |
| Model not using the retrospective prototype | 85.75 ± 3.21 |

Compared with the “Euclidean distance”-based model and the “Mahalanobis distance”-based model, the diagnostic accuracy rate of the RPN is improved by 23.81% and 5.91%. In the four configurations, the “Euclidean distance”-based model has the lowest average accuracy. This means that when each class has few samples, the conventional Euclidean distance is not applicable. Meanwhile, in view of internal data structures of the model, the classification ability of the model is enhanced indeed. With comparison on the RPN and the “Mahalanobis distance-based diagnosis model”, the CDM makes use of internal structures of the few samples better, improving the diagnostic accuracy. In addition, the RPN improves the average accuracy rate by 5.02% over the model “not using the retrospective prototype”. This indicates that the proposed retrospective prototype can represent the sample feature distribution of the same class more accurately, thereby improving the accuracy rate of the diagnostic network.

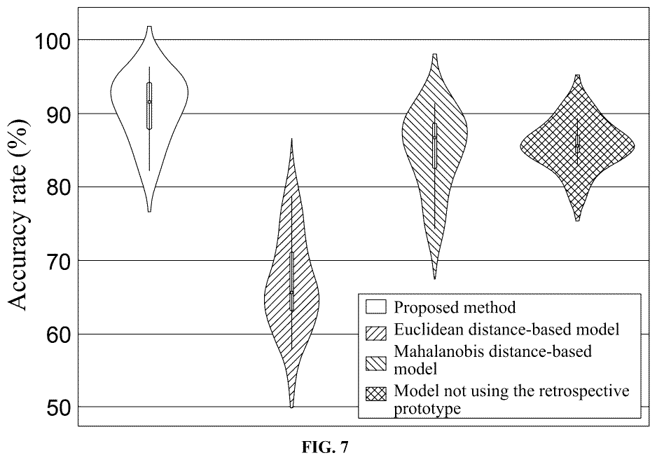

To illustrate overall distributions for diagnostic results obtained by the four models, corresponding violin plots are drawn in FIG. 7. In the figure, the fine line in the center of the violin plot represents a 95% confidence interval, the thick line represents a quartile range, and the central dot represents a median. As can be seen from FIG. 7, the diagnostic results of the RPN are more dispersed than the diagnostic results of the model “not using the retrospective prototype”. This is because the randomness of the initial value of the parameter in the RPN causes variability in model performance. However, the model-independent parameter is unnecessarily initialized according to professional knowledge and experience, and adaptively updated according to different fault diagnosis tasks. In addition, the diagnostic results obtained by the RPN are clustered to an upper region, indicating that the most probable model performance surpasses the median level.

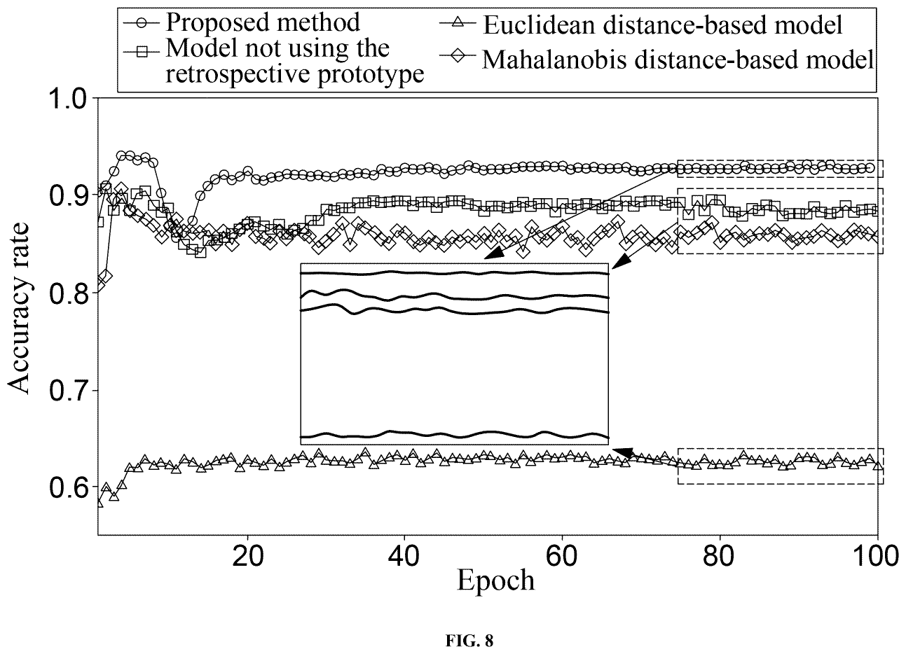

Convergence curves of the four models in accuracy during training are shown in FIG. 8. As can be seen from the figure, after stabilization, the RPN achieves the highest diagnostic accuracy while also exhibiting the minimal fluctuations in its accuracy curve. Compared with other three models, the RPN exhibits stronger diagnosability and training stability.

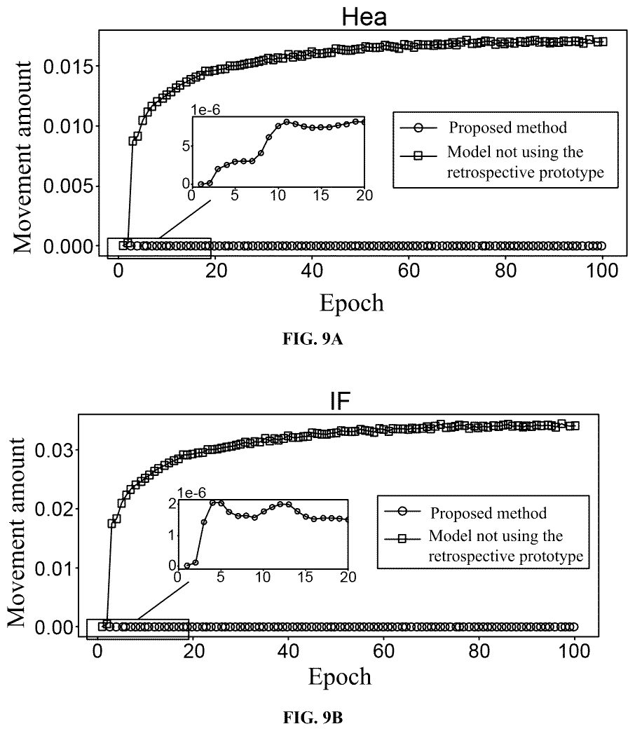

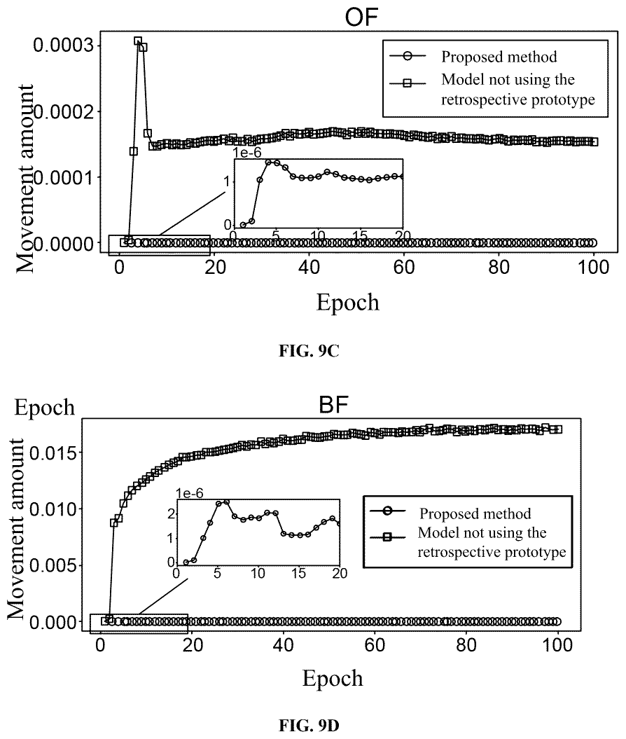

To demonstrate the prototype oscillation during training and further validate the enhanced stability of the proposed model, FIGS. 9A-9D illustrates fluctuation in prototype positions of four health states (Hea, IF, OF, and BF) obtained in two updated modes with the epoch. For each health state, the fluctuation per epoch is quantized by an average Frobenius norm for differences between two consecutive prototypes across all adjacent batches in the epoch, and labeled as an average movement amount. As can be seen from FIGS. 9A-9D, in each health state, the prototype fluctuation of the model “not using the retrospective prototype” is far greater than that of the RPN. This demonstrates that the retrospective prototype can effectively suppress the prototype oscillation, and reduces feature distribution differences between two batches, thereby enhancing the training stability of the few-shot fault diagnosis network.

In conclusion, results in the ablation experiment validate that the retrospective prototype method and the CDM proposed by the present disclosure improve diagnostic performance of the ProtoNet. Therefore, the proposed method can be better applied to the cross-machine few-dot fault diagnosis.

It should be noted that the above embodiments are only intended to explain, rather than to limit the technical solutions of the present disclosure. Although the present disclosure is described in detail with reference to the preferred embodiments, those skilled in the art should understand that modifications or equivalent substitutions may be made to the technical solutions of the present disclosure without departing from the spirit and scope of the technical solutions of the present disclosure, and such modifications or equivalent substitutions should be included within the scope of the claims of the present disclosure.

What is claimed is:

1. A cross-machine few-shot fault diagnosis method based on a retrospective prototypical network (RPN), comprising the following steps:
S1: acquiring bearing fault signal samples through a rolling bearing test bed;
S2: classifying a support set and a query set in a source domain and a target domain, and generating meta-tasks for a training stage and a testing stage;
S3: constructing a multi-scale hybrid dilated convolutional feature extraction module to obtain highly abstract sample features;
S4: calculating class prototypes, and retrospectively updating positions of the class prototypes in an embedded space;
S5: evaluating a similarity between a query sample and each of the class prototypes with a central difference metric (CDM), diagnosing a health state of the query sample, calculating a fusion loss, a separability loss, and a classification loss, and updating model parameters via backpropagation; and
S6: rapidly adapting to a meta-task in the target domain through a well-trained RPN, and diagnosing a health state of a sample in the target domain with a retrospective prototype and a CDM-based classifier.

2. The cross-machine few-shot fault diagnosis method based on an RPN according to claim 1, wherein the step S3 comprises: allowing the multi-scale hybrid dilated convolutional feature extraction module to use three convolutional layers of different sizes, and introducing an Inception module, thereby further increasing diversity of features through parallel convolution at different scales.

3. The cross-machine few-shot fault diagnosis method based on an RPN according to claim 1, wherein the step S3 comprises: allowing the multi-scale hybrid dilated convolutional feature extraction module to use dilated convolution to expand a receptive field of a convolution kernel without increasing a number of parameters, so as to enhance an ability of the multi-scale hybrid dilated convolutional feature extraction module to capture a larger local structure.

4. The cross-machine few-shot fault diagnosis method based on an RPN according to claim 1, wherein the step S3 comprises: allowing the multi-scale hybrid dilated convolutional feature extraction module to flexibly integrate multi-scale features with an adaptive pooling layer to obtain the highly abstract sample features, thereby effectively extracting fault information from a vibration signal acquired in a complex scenario.

5. The cross-machine few-shot fault diagnosis method based on an RPN according to claim 1, wherein the step S4 comprises: in a p-dimensional embedded space, defining a sample feature matrix of an nth class as
$${F}_{n} = {( {f}_{1 , n}^{S} , {f}_{2 , n}^{S} , … , {f}_{k , n}^{S} )}^{T} ,$$
wherein a sample feature
$${f}_{i , n}^{S}$$
comprises p eigenvalues; and a mean of a sample of the nth class is represented as
$${μ}_{n} = \frac{1}{k} {\sum }_{i = 1}^{k} {f}_{i , n}^{S} ;$$
and
defining a new prototype with a covariance matrix, and calculating the new prototype by:
$${P}_{n} = {\sum }_{n} = \frac{1}{k - 1} {\sum }_{i = 1}^{k} {( {f}_{i , n}^{S} - {μ}_{n} )}^{T} \cdot ( {f}_{i , n}^{S} - {μ}_{n} )$$
wherein Pₙ represents a class prototype of the nth class, and Σₙ represents a covariance matrix of the nth class.

6. The cross-machine few-shot fault diagnosis method based on an RPN according to claim 1, wherein the step S4 comprises: assuming a prototype of an ith batch as
$${\tilde{P}}_{n}^{( i )} ,$$
and a prototype of an (i+1)th batch as
$${P}_{n}^{( i + 1 )} ;$$
and with two model-independent parameters comprising a historical weight α and a present weight β, performing retrospective update, a retrospective prototype of the (i+1)th batch being represented as:
$${\tilde{P}}_{n}^{( i + 1 )} = α {\tilde{P}}_{n}^{( i )} + β {P}_{n}^{( i + 1 )}$$
wherein α and β are learnable parameters; and during network training, the retrospective prototype is represented as:
$${\tilde{P}}_{n}^{( i + 1 )} = α ( α {\tilde{P}}_{n}^{( i - 1 )} + β {P}_{n}^{( i )} ) + β {P}_{n}^{( i + 1 )} = β {P}_{n}^{( i + 1 )} + αβ {P}_{n}^{( i )} + {α}^{2} β {P}_{n}^{( i - 1 )} + … + {α}^{i} β {P}_{n}^{( 1 )} .$$

7. The cross-machine few-shot fault diagnosis method based on an RPN according to claim 1, wherein the step S5 comprises: assuming that
$${f}_{n}^{Q}$$
represents a query sample feature of an nth class, and defining a central feature matrix of the query sample as:
$${\sum }_{n}^{Q} = \frac{1}{k - 1} {\sum }_{i = 1}^{k} {( {f}_{i , n}^{S} - {f}_{n}^{Q} )}^{T} \cdot ( {f}_{i , n}^{S} - {f}_{n}^{Q} )$$
$$wherein {\sum }_{n}^{Q}$$
is a pseudo-covariance matrix; the central feature matrix of the query sample is equivalent to an observed distribution for different class samples with the query sample as a center; when the query sample belongs to a class, the central feature matrix of the query sample has a relatively high similarity with a central feature matrix generated by a support sample of the class, specifically a high similarity with a distribution represented by a class prototype of the class; and the CDM is defined as:
$${d}_{CDM} ( {f}_{n}^{Q} , {P}_{n} ) = {‖ {\sum }_{n}^{Q} - {\sum }_{n} ‖}_{F} .$$

8. The cross-machine few-shot fault diagnosis method based on an RPN according to claim 7, wherein in the step S5, a class predicted probability is:
$$p ( y = n ) = \frac{{e}^{( - {d}_{CDM} ( {f}_{n}^{Q} , {P}_{n} ) )}}{{\sum }_{j = 1}^{N} {e}^{( - {d}_{CDM} ( {f}_{n}^{Q} , {P}_{j} ) )}} .$$

9. The cross-machine few-shot fault diagnosis method based on an RPN according to claim 1, wherein in the step S5, the fusion loss L_{F} is used to reduce a difference between internal structures of data in
$${\tilde{P}}_{n}^{( i + 1 )} , {\tilde{P}}_{n}^{( i )} and {P}_{n}^{( i + 1 )} ,$$
and fuse prototype information of a historical batch and prototype information of a present batch, and comprises two loss items: an extent loss l_{E} and a deviation loss l_{D}; and a fusion loss of an (i+1)th batch is:
$${L}_{F}^{( i + 1 )} ( α , β , λ ) = {\sum }_{n = 1}^{N} {l}_{n , F}^{( i + 1 )} ( α , β , λ ) = {\sum }_{i = 1}^{N} [ λ {l}_{E}^{( i + 1 )} ( α , β ) + ( 1 - λ ) {l}_{D}^{( i + 1 )} ( α , β ) ]$$
$${l}_{E}^{( i + 1 )} ( α , β ) = {( α {‖ {\tilde{P}}_{n}^{( i + 1 )} - {\tilde{P}}_{n}^{( i )} ‖}_{F} + β {‖ {\tilde{P}}_{n}^{( i + 1 )} - {P}_{n}^{( i + 1 )} ‖}_{F} )}^{2}$$
$${l}_{D}^{( i + 1 )} ( α , β ) = {( α {‖ {\tilde{P}}_{n}^{( i + 1 )} - {\tilde{P}}_{n}^{( i )} ‖}_{F} - β {‖ {\tilde{P}}_{n}^{( i + 1 )} - {P}_{n}^{( i + 1 )} ‖}_{F} )}^{2}$$
$$wherein {l}_{n , F}^{( i + 1 )}$$
is a class fusion loss of the (i+1)th batch; λ is a weighting parameter;
$${l}_{E}^{( i + 1 )} ( α , β )$$
represents an extent of fusion for information of multiple batches;
$${l}_{D}^{( i + 1 )} ( α , β )$$
is an extent of deviation; and ∥⋅∥_{F} represents a Frobenius norm.

10. The cross-machine few-shot fault diagnosis method based on an RPN according to claim 1, wherein in the step S5, to enhance separability between the retrospective prototype and an updated class prototype, a separability loss L_{S} of an (i+1) batch is:
$${L}_{S}^{( i + 1 )} ( α , β ) = ( α + β ) {\sum }_{i = 1}^{N} {\sum }_{m = n + 1}^{N} {‖ {\tilde{P}}_{n}^{( i + 1 )} - {\tilde{P}}_{m}^{( i + 1 )} ‖}_{F}^{2} .$$
